(19) United States
(12) Patent Application Publication
(10) Pub. No.: US 2008/0235082 A1
(43) Pub. Date: Sep. 25, 2008

(54) Integrated Automatic System For Managing the Access of Vehicles to Controlled Parking Areas

(76) Inventors: Gianfranco Zanotti, S. Pietro In Cariano (IT); Alessandro Zuccato, Avesa (IT)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/795,169

(22) PCT Filed: Dec. 21, 2004
(86) PCT No.: PCT/IT04/00715

§ 371 Date: Apr. 28, 2008

(51) Int. Cl. G07C 13/00

(52) U.S. Cl. 705/13

(57) ABSTRACT

An integrated automatic system for monitoring and managing the access, transit and parking of vehicles in predetermined controlled traffic areas, in particular in parking areas equipped with a plurality of individual parking spaces comprises: an electronic vehicle identification device; an electronic vehicle detection device; at least one local data processing unit; at least one central data processing unit. The data transmitted by the electronic vehicle identification device are associated with the data relative to the electronic vehicle detection device and the result of this association is transmitted to one of the local data processing units. Furthermore, the data processed by the local units are transmitted to the central processing unit which generates a signal relative to the payment of a predetermined fee for the access and/or transit and/or parking of a vehicle inside the controlled area.

### TECHNICAL FIELD

This invention concerns an integrated automatic system for monitoring and managing the access, transit and parking of vehicles in predetermined controlled parking areas.

More specifically, this invention refers to an integrated automatic system for controlling and managing spaces for parking vehicles in urban areas, which is advantageously equipped with means that avoid the need for any manual operation on the part of the user or the management personnel, and in particular avoids the need to enter access codes to obtain authorisation to park in the respective area.

According to an advantageous aspect of the invention, the system can be used without the user having to perform any manual operation, for example without being obliged to manually stamp a parking ticket during entry and/or exit.

This invention can be applied in the industry for the production of electrical and electronic automatic devices in general.

### BACKGROUND ART

It is known that the growing number of motor vehicles has made traffic problems increasingly important, forcing local authorities to impose limitations on the circulation and parking of vehicles in urban areas.

These problems are particularly evident in historical city centres and high traffic density areas, making it necessary to introduce structured systems for controlling access and parking, generally based on the designation of limited traffic areas and/or on parking fee and selective authorisation mechanisms, such as long-term access and parking permits for residents, limited permits for registered users or “time-based” fees for occasional users.

Receiver-transmitter devices for the automatic detection of the presence or transit of vehicles have already been proposed and consolidated technologies are already present on the market, one of which is the subject of the international patent application published under no. WO04/055751 in the name of the applicants themselves. This patent application describes an automated system for monitoring and managing the access to parking areas, which includes a vehicle detection sensor installed close to the parking space and connected to a fixed data collection unit.

This system nevertheless presents a series of problems.

First of all, the power of the signals must be very low in order to avoid the system being excessively complex, to limit the costs and to restrict electromagnetic pollution to negligible levels, taking into account the widespread presence of the devices in intensely visited areas.

Another problem is represented by the fact that the devices used to date do not guarantee a high degree of efficiency, presenting a considerable number of errors or cases of malfunctioning.

In addition to this, the detection and management means of these systems require the considerable use of human resources, particularly for the material operations of monitoring the areas in which access and parking are managed on a selective basis.

It was also found that the known management and detection systems have the disadvantage of forcing the user or the relative personnel to manually stamp the parking ticket during entry and/or exit.

This involves a loss of time for the user and for the personnel, with all the consequent inconveniences.

In the data transmission sector, the use of the “U.W.B. Technology” or Ultra Wide Band is also known, representing a wireless technical procedure for transmitting/receiving information, similar to other technologies such as those known with the acronyms GSM or Wi-Fi.

The Ultra Wide Band (UWB) systems transmit signals on a much wider spectrum of frequencies compared to conventional systems, and the definition of UWB applies to signals with a band of at least 25% with respect to the central frequency. For example, for a centre band frequency of 3 GHz, the system is UWB if the entire band is at least 750 MHz.

The most common way of generating an UWB signal is by transmitting impulses that last less than 1 ns.

Transmitting/receiving information with UWB is implemented by using standard commercial components. Ultra Wide Band signals consist of a series of intermittent impulses transmitted at a low frequency over a very wide band of the spectrum. The transmitted data are coded by means of the width, the duration and the polarity of these impulses.

To be able to read the data sent by means of this method, the receiving device must know its code and above all must synchronise with the message transmitting device, knowing at what intervals of time the data will be transmitted. If the receiver does not know the code and is not synchronised with the transmitter, it cannot distinguish an Ultra Wide Band signal from so-called background noise, i.e. the low power radiation generated by a hairdryer, by a computer or even by the human body.

This feature makes the Ultra Wide Band system a very secure means of transmission since it is difficult to intercept. To reinforce transmission security, the impulses are generated at apparently casual time intervals so that they are perfectly “camouflaged” with background noise.

A series of specific applications have recently been proposed for the use of UWB technology in the transport sector. However, these applications are connected to anticollision systems, while Ultra Wide Band technology never appears to have been used for monitoring and managing public or private spaces, nor for controlling parking fee and selective authorisation mechanisms.

Finally, the data transmission sector has also made use of the so-called active tags, i.e. very low power wireless data transmission devices which comprise a microprocessor, support circuitry and an antenna.

The active tags have a non-volatile memory containing a single code which is transmitted to, a special reader with a memory that identifies the object or the means on which the active tag is installed.

The active tags contain their own power source, usually a small lithium battery, which normally lasts for several years.

### DESCRIPTION OF THE INVENTION

This invention proposes to provide an integrated automatic system for the remote monitoring and management of vehicle access and parking, particularly in urban areas, which can eliminate or significantly reduce the problems described above.

This invention proposes in particular to provide an automatic system that can guarantee the possibility of identifying vehicles in transit and/or parking in dedicated parking areas, and of identifying whether the vehicle that has entered the controlled area is authorised to access, transit and park in a certain space in the area.

This all takes place without the user or the management personnel having to enter check codes or perform the traditional parking ticket stamping operations.

This is achieved by means of a system with the features described in the main claim.

The dependent claims described advantageous embodiments of the invention.

According to a preferred embodiment, the integrated automatic system according to the invention comprises the following main components:
a) at least one electronic vehicle identification device, comprising a memory in which the data or codes relative to the vehicle and/or its owner are stored, and means designed to allow the remote transmission of these data;
b) a series of vehicle detection devices, each of which is positioned in correspondence with a space (above or below the road surface) in the parking area to be monitored, each vehicle detection device being equipped with appropriate means for reading and memorising the codes present in each controlled vehicle;
c) at least one local data processing unit, designed to receive the information sent by the vehicle detection devices, to process the information and to transmit the processed data;
d) at least one central data processing unit, designed to receive the information sent by the local data processing units, to further process the information and to further transmit the processed data to other processing units, in particular to data processing centres belonging to banks or similar financial institutions.

According to a first particularly advantageous embodiment of the system according to the invention, the vehicle identification device consists of a radiofrequency device normally defined as an “active tag”.

According to-another advantageous embodiment of the system according to the invention, the vehicle identification device consists of a transponder.

According to yet another advantageous embodiment of the invention, the transmission of data from the vehicle detection devices to the corresponding local processing unit takes place physically via cable (for example, an electric or fibre optic cable, etc.); however, according to a particularly advantageous embodiment of the invention, this data transmission takes place using wireless technology. An absolutely preferred embodiment of the invention foresees the use of Ultra Wide Band (UWB) technology for identification of the vehicle and/or for the transmission of the data to the local processing units.

According to yet another embodiment of the invention, the local data processing unit also comprises a device for payment by notes or coins or electronic means for payment by credit card, prepaid cards or similar, this payment device being employed by users not equipped with the vehicle identification device described above.

Again, according to another embodiment of the invention, the central processing unit that receives the data from the various local units processes the information received and, on the basis of the vehicle identification data sent by the respective identification device, debits the parking fee according to the tariffs in force for the specific parking area where the identified vehicle is parked.

From the above description it can be seen that, according to this invention, the location of a vehicle in the parking space is determined by associating the vehicle presence information, detected by the vehicle detection device, with the information of each respective vehicle identification electronic device.

As mentioned above, the association of this information can be carried out by using various technologies, which differ from each other substantially in the degree of detection accuracy. According to a preferred embodiment, excellent locating precision can be achieved by fitting the vehicle to be identified with an identification device that, preferably at intervals, transmits an identification code preferably using the UWB (Ultra Wide Band) technology, and at the same time positioning inside the area a series of local data processing units which, by using the UWB technology, carry out the triangulation of the position of the transmitter.

According to an alternative embodiment mentioned above, the identification device fitted on a vehicle consists of an “active tag” radiofrequency device, comprising miniaturised equipment equipped with a memory containing an identification code of the user.

This code is transmitted automatically by radiofrequency to the vehicle detection devices located at the entrances to or in the parking spaces in the areas covered by the system.

The integrated automatic system according to the invention makes it possible to rationalise and properly manage the problems connected with access, transit and parking in urban areas, avoiding the need for manual parking ticket stamping operations.

In fact, thanks to the use of the system according to the invention every manual action on the part of the vehicle driver is eliminated, since the vehicle is identified automatically by the system which then carries out the necessary payment operations without any further action on the part of the user.

This system provides high levels of reliability for the user, with reference to the security of the data contained in the memory of a miniaturised circuit, and considerably reduces the work of the management personnel.

### DESCRIPTION OF THE DRAWINGS

Other features and advantages of the invention will become evident on reading the following description of one embodiment of the invention, given as a non-binding example, with the help of the accompanying drawings in which:

FIG. 1 represents a prospective schematic view, slightly from above, of a parking area equipped with devices making up the system according to the invention;

FIG. 2 is a diagram of a group of an undefined number of parking spaces managed by the same local data processing unit;

FIG. 3 is a schematic view of an example of the management of several groups of parking spaces served by respective local data processing units and by a central processing unit; and

FIG. 4 is a schematic view of an example of the management of the system using spatial location of the vehicles by means of Ultra Wide Band (UWB) technology.

### DESCRIPTION OF ONE EMBODIMENT

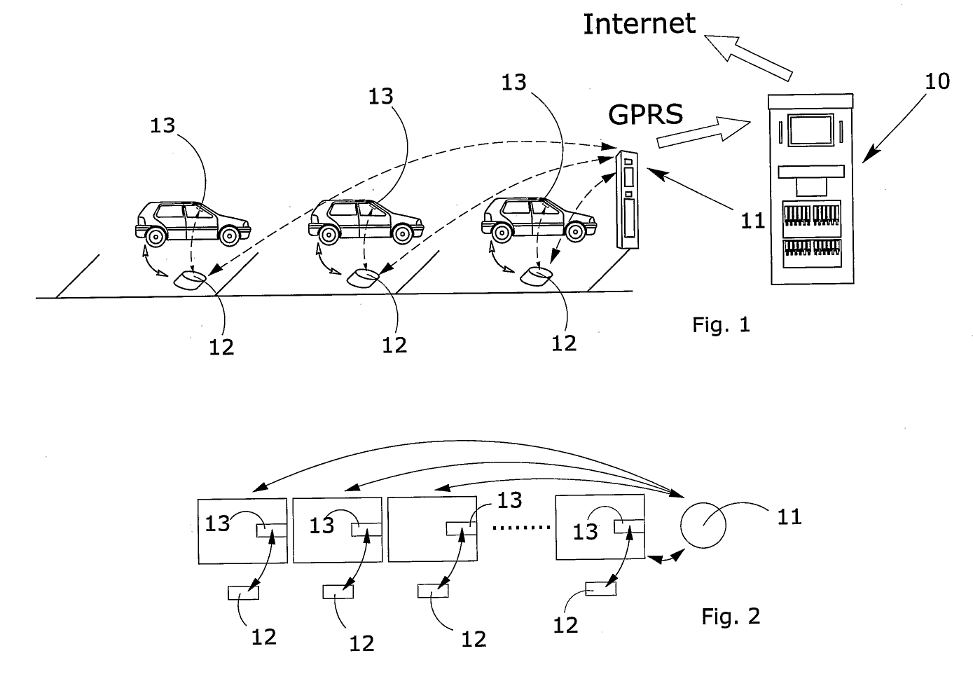

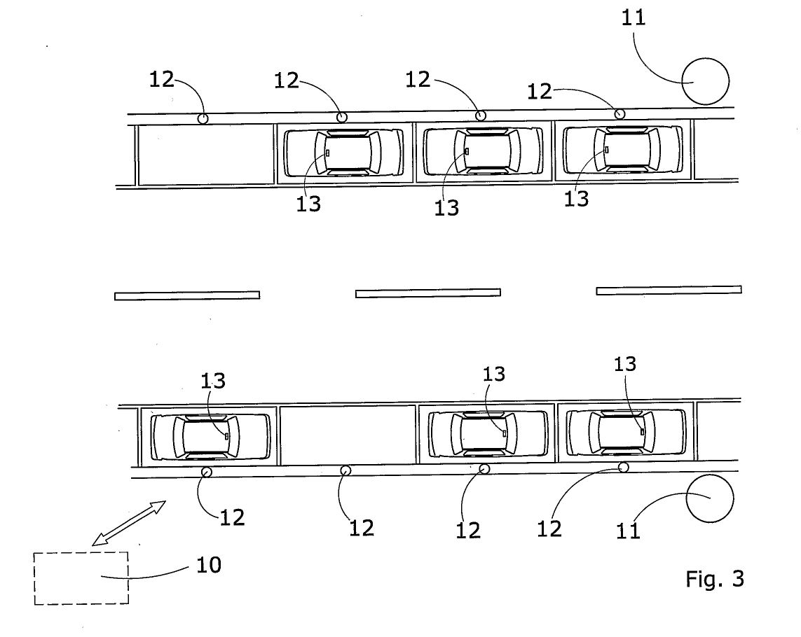

In FIG. 1, the reference number 10 indicates in general a central data processing unit which, according to one embodiment, manages and processes the information received by means of GPRS signals or another data transmission radio system from a local data processing unit 11.

This central processing unit 10 typically consists of an IT (information technology) infrastructure, generally located in a position assigned for the control of various parking or transit areas in a city or in any case of an area which is kept under control.

This central unit 10 normally receives data and information from a plurality of local processing units 11, and process the received data so that they can be:
permanently memorised (“historical data”);
presented, also in aggregate form, in a way that is easily understood by operators (“user interface”) also for subsequent processing.

According to the invention, the local data processing units 11 generally consist of receiver-transmitter devices, designed to receive the information transmitted by a plurality of vehicle presence detection devices 12, memorise the data on a transitory basis and transmit the data to the central unit 10.

The reception-transmission of the data from and to the local processing units 11 can take place by means of a coaxial connection (i.e. via cable) or by. means of radio waves (for example by means of GPRS or another radio communication system).

Communication of the data from the vehicle identification devices 13 to the vehicle detection devices 12 can also take place by means of radio waves.

From a design point of view, a local unit 11 is generally able to manage a plurality of vehicle detection devices 12 for each parking area covered by the system.

In general, each local data processing unit 11 consists of a fixed column, equipped with a cable or wireless receiver of the data from the vehicle detection devices 12, and a cable or wireless transmitter of the data to the central data processing unit 10.

According to an advantageous embodiment of the invention, each vehicle detection device 12 is equipped with the following main subsystems:
a sensor for detecting the presence of a vehicle parked in the space;
a reader for the signal transmitted by the vehicle identification device 13;
a cable or wireless transmitter for sending the data to the local processing device 11.

In this case, each vehicle involved is fitted with an electronic vehicle identification device 13, advantageously an active tag, equipped with a wireless transmitter of the identification code of the vehicle which for example sends coded signals at programmed intervals.

In this case identification devices 13 of the active tag type are used, i.e. miniaturised equipment that can be fitted on the vehicle and in which an identification code associated with the vehicle and/or the vehicle owner is memorised.

From the procedural point of view, the central processing unit 10 receives the data from the various local units 11 and processes this information.

On the basis of the vehicle identification data sent by the vehicle identification devices 13, the central unit 10 debits the parking or transit fees according to the tariffs in force in the area controlled by the system.

According to the invention the location of vehicle in the space is determined by associating the following information:
the presence detected by the vehicle detection device 12;
the identification code transmitted by the vehicle identification device 13.
To increase the location precision, a particularly advantageous embodiment of the invention foresees the use of Ultra Wide Band (UWB) technology.

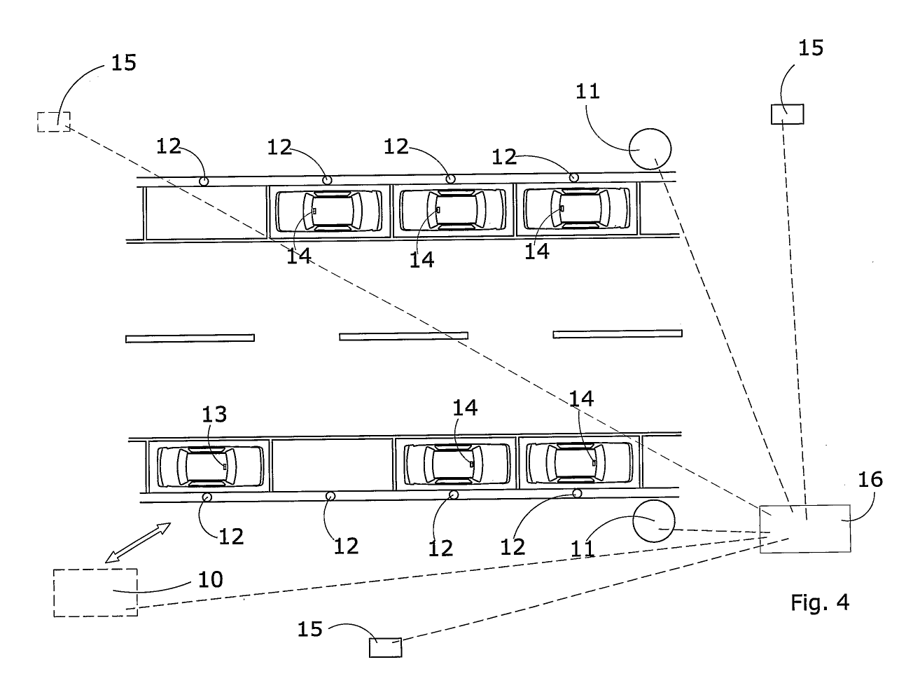

With reference to FIG. 4, in this case the system according to the invention foresees the presence of:
a vehicle identification device 14 that transmits an identification code using UWB (Ultra Wide Band) technology, this device 14 generally consisting of a transponder;
a series of area receivers 15 (normally three or four) which, using UWB technology, carry out a triangulation locating with absolute precision the position of the transmitter 14 fitted on the vehicle. In particular, each receiver 15 measures the time that passes from transmission to reception (obviously using the same time reference), taking into account the fact that electromagnetic waves travel through space at a finite speed, and a processor 16, generally positioned in correspondence with the local data processing unit, using the information described above and a simple standard mathematical formula, determines the spatial position x,y of the controlled vehicle.
The information relative to the triangulation carried out by the UWB system is obviously associated with the information transmitted by the vehicle detection devices 12 and processed as described above by the local processing unit.

It can be seen that the UWB technology is particularly appropriate for this application, thanks to the nature of the impulses lasting only nanoseconds, these impulses having a “time-of-flight” which can be determined accurately.

It should also be noted that the identification code of the vehicle is transmitted automatically via cable or radiofrequency, once detected by the receivers 15 and processed by the processor 16, to a local processing unit 11 (and then to the central processing unit 10, see FIG. 1) in order to allow debiting of the parking fee or confirmation of authorisation to access a certain area.

The integrated automatic system for remote monitoring and management of the access, transit and parking of vehicles in predetermined controlled traffic areas makes it possible to rationalise and properly manage the problems connected with access, transit and parking in these areas, avoiding the need to carry out any parking ticket stamping operations since the system functions in a completely automatic way.

The invention is described above with reference to a particularly advantageous embodiment.

It is nevertheless clear that it is susceptible to numerous variations within the framework of technical equivalents.

1. An integrated automatic system for monitoring and managing the access, transit and parking of vehicles in predetermined controlled traffic areas, in particular in parking areas equipped with a plurality of individual parking spaces, this system comprising:
an electronic vehicle identification device fitted on each vehicle, comprising a memory in which the data or codes relative to the vehicle and/or to the vehicle owner are memorized, and means designed to allow the remote transmission of these data;
an electronic vehicle detection device positioned in each individual parking space and equipped with appropriate means for reading and memorizing the data present in each controlled vehicle, and means designed to allow the remote transmission of these data;
at least one local data processing unit designed to receive the information transmitted by the vehicle detection devices, to process this information and to transmit the processed data; and
at least one central data processing unit, designed to receive the information transmitted by the local data processing units, to further process the information and to further transmit the information to other processing units, in particular to data processing centers belonging to banks or similar financial institutions, or to directly emit signals allowing the access, transit or parking of a vehicle inside the monitored area;
this automatic system wherein the data transmitted by the electronic vehicle identification device are associated with the data relative to the electronic vehicle detection device, the result of this association being transmitted to one of the local data processing units and in that the data processed by the local units are transmitted to the central processing unit which generates a signal relative to the payment of a predetermined fee for the access and/or transit and/or parking of a vehicle inside the controlled area.

2. An integrated automatic system according to claim 1, wherein the electronic vehicle identification device consists of a radiofrequency device of the type normally defined as “active tag”.

3. An integrated automatic system according to claim 2, wherein the “active tag” device includes a wireless transmitter and a memory in which the vehicle identification code is stored.

4. An integrated automatic system according to claim 1, wherein the transmission of the data from the vehicle detection device to the corresponding local data processing unit takes place physically via an electrical cable or a fiber optic cable.

5. An integrated automatic system according to claim 1, wherein the transmission of the data from the vehicle detection device to the corresponding local data processing unit takes place in wireless mode.

6. An integrated automatic system according to claim 5, wherein the transmission of the data from the vehicle detection device to the corresponding local data processing unit takes place by using Ultra Wide Band (UWB) technology for vehicle identification and/or for data transmission to the local processing units.

7. An automatic system according to claim 6, wherein the electronic vehicle identification device consists of a transponder.

8. An integrated automatic system according to claim 1, wherein the at least one local data processing unit also comprises a unit for payment in bank notes or electronic means for payment by credit card, prepaid card or similar, this payment unit to be employed by users not equipped with vehicle identification devices.

9. An integrated automatic system according to claim 1, wherein the central processing unit that receives the data from the various local units processes the information it receives from them and, on the basis of the vehicle identification data sent by each respective identification device and of the data received from the vehicle detection device, the central unit debits the fees according to the tariffs in force for the specific area under control.

10. An integrated automatic system according to claim 1, wherein in order to use the UWB technology it also comprises a series of area receivers that carry out a triangulation locating with absolute precision the position of the transmitter fitted on the vehicle.

11. An automatic system according to claim 10, wherein it also comprises a processor, generally positioned in correspondence with a local data processing unit, which determines the spatial position x,y of the controlled vehicle, the information relative to the triangulation carried out by the UWB system being associated with the information transmitted by the vehicle detection devices and processed by the local processing unit.
